(19) United States
(12) Patent Application Publication
(10) Pub. No.: US 2020/0003355 A1
(43) Pub. Date: Jan. 2, 2020

(54) ABRASION RESISTANT PATCH FOR ELASTOMERIC HOSES

(71) Applicant: ContiTech Techno-Chemie GmbH, Karben (DE)

(72) Inventor: Joseph P. Schultz, Dover, NH (US)

(73) Assignee: ContiTech Techno-Chemie GmbH, Karben (DE)

(21) Appl. No.: 16/021,049

(22) Filed: Jun. 28, 2018

(51) Int. Cl. F16L 57/06; F02M 35/10; F16L 11/115; F16L 11/10; D03D 3/02

(52) U.S. Cl. CPC F16L 57/06; F02M 35/10137; F02M 35/10334; D10B 2505/12; F16L 11/10; D03D 3/02; F16L 11/115

(57) ABSTRACT

Charge air hoses or engine coolant hoses including a hose-shaped base member, a textile reinforcement arranged to directly contact the surface of the base member, an outer layer arranged outwardly the textile reinforcement, where the outer layer defines an outer surface of the hoses, and an abrasion resistant reinforcement patch embedded in localized area of the outer surface of the hoses. In some aspects, the abrasion resistant reinforcement patch is in contact with another underhood component. In some aspects, the abrasion resistant reinforcement patch may include a woven fabric, a knitted fabric, a fabric mesh or a fabric braid. Also yarns forming the abrasion resistant reinforcement patch may be provided with an impregnation. The abrasion resistant reinforcement patch may also have a coating.

### FIELD

The field to which the disclosure generally relates is elastomeric automotive hoses, and more particularly to charge air hoses or coolant hoses for motor vehicles having a hose-shaped matrix and a textile based abrasion resistant element therein.

### BACKGROUND

This section provides background information to facilitate a better understanding of the various aspects of the disclosure. It should be understood that the statements in this section of this document are to be read in this light, and not as admissions of prior art.

Charge air hoses and coolant hoses with textile reinforcements are known from the prior art, where the textile reinforcement is embedded into an elastomer matrix or between two elastomer layers. These conventional textile-reinforced hoses are exposed to significant mechanical work when being dynamically stressed, while in use. Furthermore, due to movement of these hoses and/or other components within the engine compartment of a motor vehicle, such items can come in contact with one another, and/or move against each other, which causes abrasion and potential failure of the hose.

Existing methods of protecting hoses from such abrasion due to contact with other underhood components are to cover the hose with a secondary abrasion resistant sleeve made of either nylon, polyester or a combination of both, and/or to mold in place a thick section of extraneous elastomer to serve as a sacrificial material to prolong the hose life. Both of these solutions must be applied in a post operation after the hose is produced, and require additional labor, and possibly costly fixturing and tooling to accomplish. Additionally, the installation of the abrasion resistant sleeving can be difficult and time consuming. Also, both existing solutions are not aesthetically pleasing.

Thus, there is an ongoing need for hoses, such as those described above, using more efficient manufacturing techniques, having lighter weight, and more aesthetically pleasing, while having sufficient abrasion resistance in underhood conditions, such need met, at least in part, with embodiments according to the following disclosure.

### SUMMARY

This section provides a general summary of the disclosure, and is not a necessarily a comprehensive disclosure of its full scope or all of its features.

In a first aspect of the disclosure, a charge air hose for motor vehicles, includes a hose-shaped base member, a textile reinforcement arranged to directly contact the surface of the base member, an outer layer arranged outwardly the textile reinforcement, where the outer layer defines an outer surface of the charge air hose, and an abrasion resistant reinforcement patch embedded in, as well as being an integral part of, a localized area of the outer surface of the charge air hose. In some aspects, the abrasion resistant reinforcement patch is in contact with another underhood component. The hose-shaped base member may be an unvulcanized, elastomer-containing hose. The textile reinforcement may be formed of one or more of a woven fabric, knitted fabric, knitted reinforcement or braided reinforcement. In some cases, yarns forming the textile reinforcement are provided with an impregnation.

In some aspects, the abrasion resistant reinforcement patch may include a woven fabric, a knitted fabric, a fabric mesh or a fabric braid. Also yarns forming the abrasion resistant reinforcement patch may be provided with an impregnation. The abrasion resistant reinforcement patch may also have a coating.

In another aspect of the disclosure, an engine coolant hose includes a hose-shaped base member, a textile reinforcement arranged to directly contact the surface of the base member, an outer layer arranged outwardly the textile reinforcement, where the outer layer defines an outer surface of the engine coolant hose, and an abrasion resistant reinforcement patch embedded in, as well as being an integral part of, a localized area of the outer surface of the hose. In some aspects, the abrasion resistant reinforcement patch is in contact with another underhood component. The hose-shaped base member may be an unvulcanized, elastomer-containing hose. The textile reinforcement may be formed of one or more of a woven fabric, knitted fabric, knitted reinforcement or braided reinforcement. In some cases, yarns forming the textile reinforcement are provided with an impregnation.

In some aspects, the abrasion resistant reinforcement patch may include a woven fabric, a knitted fabric, a fabric mesh or a fabric braid. Also yarns forming the abrasion resistant reinforcement patch may be provided with an impregnation. The abrasion resistant reinforcement patch may also have a coating.

In yet other aspects of the disclosure, methods of manufacturing a hose for motor vehicles includes providing an elastomer-containing hose as a hose-shaped base member, applying a textile reinforcement directly onto the surface of the elastomer-containing hose, applying an outer layer arranged outwardly from the textile reinforcement, where the outer layer defines an outer surface of the hose, embedding an abrasion resistant reinforcement patch in localized area of the outer surface of the hose, and vulcanizing the hose.

### BRIEF DESCRIPTION OF THE DRAWINGS

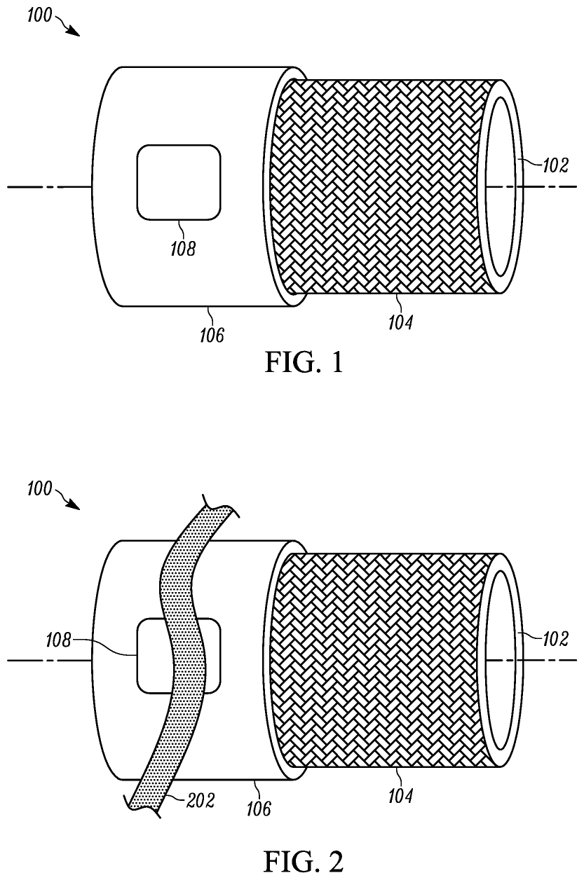

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein. FIGS. 1 and 2 show perspective views of the charge air hose embodiments in accordance with the disclosure.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Some embodiments according to the disclosure utilize an abrasion resistant textile that has been coated with an elastomer. The coated textile is then cut into a shape appropriate to fit in a prescribed position on the hose, thus forming an abrasion resistant reinforcement patch. The patch is placed onto the hose, and permanently bonded in place during the hose curing process. Embodiments of the disclosure may also provide the requirement for a protective feature of the hose to prevent damage or failure due to abrasion from other underhood components.

Some unexpected advantages of embodiments of the disclosure, over the existing state of the art, are the patch forming material is bonded permanently to the hose, it can be placed in small localized areas only where the abrasion resistance is required on the part, and there is no need to cover large sections of the hose, or be anchored in place to prevent dislodgement such as required abrasion resistant sleeve. Additionally, the patch maybe formed of a very lightweight material, thus not adding excess bulk to the hose, like the addition of a thick overmolded section. Furthermore, embodiments of the disclosure require no additional tooling or fixturing to accomplish this feature, as well as additional labor cost is minimal.

In some embodiments, the hoses are wrapped or discretely produced extruded silicone or elastomeric hoses, but not continuously produced or “bulk” hoses. Such hose are typically used for turbocharger or water cooling applications. In accordance with disclosure, an abrasion resistant material is produced separately, then cut out as a “patch” and applied to the hose just prior to the vulcanization process. It then becomes an integral part of the finished hose. The hose may be prepared by extrusion, left completely uncured, then cut to length, formed onto a mandrel and vulcanized as an individual hose.

As described above, some hoses according to the disclosure include a hose-shaped base member, a textile reinforcement arranged on the surface of the base member, an outer layer arranged outwardly from the textile reinforcement, where the outer layer defines an outer surface of the charge air hose, and an abrasion resistant reinforcement patch embedded in localized area of the outer surface of the charge air hose. The hose-like base member and outer layer are formed of a vulcanizable, elastomer-containing material. The textile reinforcement and an abrasion resistant reinforcement patch are applied onto the elastomers in non-vulcanized state during a manufacturing process. Due to the non-vulcanized state the elastomers, they are soft. Caused by the soft state of the elastomers and caused by the yarn tension during manufacture of the textile reinforcement and other procedural circumstances, the reinforcement and patch penetrates the elastomers' surface. The contact surface between the elastomers the reinforcement and the abrasion resistant reinforcement patch is therefore three-dimensional. The elastomers enclose the yarns of the reinforcement, and entrain at least the underside of the abrasion resistant reinforcement patch. With such a contact surface and at a dynamical load of the hose, the power transmission between the elastomers, the textile reinforcement and the abrasion resistant reinforcement patch is both non-positive (axially with respect to the yarn) as well as positive (radially with respect to the yarn).

In some embodiments of the invention, the hose-shaped base member is formed as an unvulcanized elastomer hose. The elastomer-containing hose may have a substantially smooth surface. This measure reduces friction between the reinforcement and the base member, which increases life of the hose when being loaded dynamically.

In some embodiments the elastomer-containing hose is manufactured by an extrusion or injection molding process. These manufacturing methods prove to be especially economical in connection with elastomer-containing hoses. Alternatively, the hoses may be built by a wrapping process on a mandrel. The hose may also be built up from rubber coated textile sheets, such as produced by the calendaring process, or other method of coating of a reinforcement textile. In the end, the hose may be vulcanized by many methods, including hot air, autoclave and other molding processes.

In some embodiments of the disclosure, the elastomers used in hose thermoplastic elastomers. By the addition of a thermoplastic elastomer the dynamical and mechanical properties of the hose can specifically be adjusted. In some other aspects of the disclosure, the elastomers used in hose silicone elastomers. In some other embodiments of the disclosure, thermosetting elastomers, or those elastomers with an irreversible cross-linking of the polymer chains, may be used.

In some embodiments, the textile reinforcement the abrasion resistant reinforcement patch are formed from a knitted fabric or as a braid. The reinforcement can be designed such that it rests properly on the elastomer-containing hose and that its deformation does not exceed the range of its structural expansion. The reinforcement is therefore in a lower tension state than is the case with the conventional charge air hose, which above that is regular across the entire hose surface. Structural and material expansion are the two classical elastic expansion states of a textile structure. A textile structure is deformed by very low forces in the area of the structural expansion. The reason for this is that the yarns can slide against one another in a predetermined manner depending on the textile structure (knitted fabric, braid) and the textile structure can therefore adopt other shapes without the yarns being loaded mechanically. If the structure is further expanded, the portion of the material expansion starts. In the last mentioned expansion state the yarn structure is loaded. Small deformations of the component are connected with high forces.

Any existing or conceivable textile structure can be used or applied in a defined tension state, for the reinforcement and the abrasion resistant reinforcement patch. This not only enables the use of charge air hoses for significantly higher pressure ranges than the hoses formerly used in the automotive range, but also enables a controlled volume increase of the hose during operation, which is a significant progress in view of the constantly decreasing space available in the engine compartment. The textile structure is enormously flexible, and the dynamic or mechanical power behavior can be adjusted through the braid angle or extract. The fineness or strength of the yarn is freely selectable according to the respective requirement profile, since compared to an internal reinforcement as in a conventional charge air hose there is no interaction (notch effect) between the reinforcement, the patch, and the matrix. In conventional charge air hoses, the adhesion between the layers additionally plays an essential role. In so far the strength of the yarn is limited. The stronger the yarn the worse the layer bond in the original state. The reinforcement can be applied by a form-fitting weaving-around operation, which is particularly suitable for smooth hoses. The application of a pre-fabricated braid or knitted fabric (e.g. a pre-fabricated braid hose) proves to be an option and is particularly suitable for corrugated hoses.

In some embodiments of the disclosure, the textile reinforcement and/or the abrasion resistant reinforcement patch are made of glass filament. Glass filaments belong to the high-strength yarn materials, they are inexpensive and are characterized by high thermal and chemical resistance and by a very low expansibility.

In some embodiments of the disclosure, textile reinforcement and/or the abrasion resistant reinforcement patch is formed as a 3D braid or textile. This manufacturing method enables an especially high adaptation to the shape of the base member and thus an especially low relative movement of the textile reinforcement towards the base member when the hose is dynamically loaded. Textiles used may be flat woven or even a three dimensional textile that is produced by stitching together two flat materials to produce a 3D lattice, that has significant thickness. Materials of this type may be useful for the abrasion resistant patch.

In some aspects, the textile reinforcement surrounds the molded hose properly. When the hose is dynamically loaded, a low relative movement between the base member and the reinforcement takes place.

For some hose embodiments, the textile reinforcement and/or the abrasion resistant reinforcement patch are impregnated and/or coated by a coating material. This protects the reinforcement and the patch against wear, e.g. caused by friction. Furthermore, the textile reinforcement and/or the abrasion resistant reinforcement patch are provided in a cut-proof manner and are thereby protected against fraying of the individual filaments. Furthermore, the impregnation or coating of the reinforcement and patch serves for fixing on the hose surface or for assembly adhesion. Furthermore, the yarn filaments are protected in view of the connection (e.g. to a hose by means of hose clamps, couplings, etc).

In some aspects, the yarn of the textile reinforcement and/or the abrasion resistant reinforcement patch are provided with an impregnation. The impregnation is applied preferably prior to manufacture of the textile reinforcement or patch, i.e. before braiding or knitting. This measure also serves for protecting the yarn, the textile reinforcement and the abrasion resistant reinforcement patch against wear. This protection is especially important at the yarn intersecting points of the textile reinforcement or patch which are a weak point with respect to yarn/yarn friction.

The coating material may be a resin or an elastomer, or even a silicone elastomer. The flexible resin or elastomeric coating e.g. in the form of solutions or lattices is a suitable material. When using a textile reinforcement and/or an abrasion resistant reinforcement patch having glass filaments, an adhesion-modified silicon elastomer may be used as coating material, by means of which a universal temperature resistance, high flexibility and favorable adhesion to the glass fiber filaments can be achieved.

In some cases the coating material may be applied by submersion, varnishing or coating of the hose during construction thereof, or by extrusion when braided hoses with later crosslinking are used, since the elastomeric coating material must fundamentally be vulcanized after application, preferably by an online method.

The textile reinforcement may be embedded on at least one hose end into a material adhesively joined with the base member. Also, the hose may be coated at the hose end. This prevents a detachment or fraying of the textile reinforcement and serves for functionalizing the hose ends in view of the connection and integration of functions, e.g. in the clamp seat, clamp fixing, installation marking, etc.

A first embodiment of the invention will now be described with reference to FIGS. 1 and 2. FIG. 1 shows a perspective view of the charge air hose 100 (which may also be an engine coolant hose) according to the disclosure. The charge air hose 100 according to the first embodiment includes a vulcanizable elastomeric hose 102 as a hose-shaped base member and a textile reinforcement 104 arranged at or on the hose surface. The textile reinforcement 104 is shown symbolically in FIG. 1 and is preferably formed as a knitted fabric or braid of fibers or filaments. The charge air hose 100 further includes an outer layer 106 arranged outwardly the textile reinforcement, and the outer layer defines an outer surface of charge air hose 100. Additionally, the charge air hose 100 further includes an abrasion resistant reinforcement patch 108 embedded in localized area of the outer surface of the charge air hose.

In some embodiments, the hose-shaped base member is a vulcanized, elastomer-containing hose. Also in some cases, yarns or filaments of the textile reinforcement are provided with an impregnation.

FIG. 2 shows a cross-sectional section of the charge air hose 100 of the first embodiment of FIG. 1. As can be seen in FIG. 2, abrasion resistant reinforcement patch 108, embedded in the selected area of the outer surface of the charge air hose, is in contact with another underhood component 202. Such contact may be direct continuous contact, movable contact, occasional contact, vibrational contact where the underhood component 202 makes contact with abrasion resistant reinforcement patch 108 during the operation of the vehicle, and the like.

The features of the embodiments mentioned and described can be combined in any manner.

Some other aspects of the disclosure are methods of manufacturing a charge air hose or coolant hose for motor vehicles, which includes the following steps: providing an elastomer-containing hose as a hose-shaped base member, applying a textile reinforcement onto the surface of the elastomer-containing hose, applying an outer layer arranged outwardly the textile reinforcement, where the outer layer defines an outer surface of the charge air hose, and embedding an abrasion resistant reinforcement patch in localized area of the outer surface of the hose.

To provide the hose 100 with additional advantageous features, the textile reinforcement 104 and/or the abrasion resistant reinforcement patch 108 can be impregnated and/or coated by the coating material before or after application to the unvulcanized, elastomer-containing hose 100. As an alternative or additionally, the yarn of the textile reinforcement 104 and/or the abrasion resistant reinforcement patch 108 can be provided with an impregnation before manufacture of such. Moreover, the textile reinforcement 104 and/or the abrasion resistant reinforcement patch 108 may be pre-fabricated before application into hose 100.

A further preferred embodiment of the method according to the invention comprises the impregnation and/or coating of the textile reinforcement by a coating material to reduce the wear of the textile reinforcement.

A further embodiment of the method according to the disclosure includes the impregnation of the yarn of the textile reinforcement 104 and/or the abrasion resistant reinforcement patch 108 with the aim of reducing wear of the textile reinforcement 104 and/or the abrasion resistant reinforcement patch 108 by reducing the yarn/yarn friction at the intersecting points of the textile reinforcement 104 and/or the abrasion resistant reinforcement patch 108.

A knitted fabric or braid is designated as textile reinforcement 104 is arranged at or on the surface of the hose-shaped base member 102 to restrict a volume increase of the hose 100. In some cases, pressure rings, made of plastics or metal may be arranged in the wave troughs of the corrugated hose to hold the textile reinforcement in the wave troughs possibly tightly at the hose surface.

In some aspects, to functionalize the hose ends in view of the connection and integration of functions, e.g. clamp seat, clamp fixing, installation marks, the hose ends can be coated or pre-fabricated caps, such as elastomeric caps, or functionalized, elastomeric hose sections can be adhered and/or vulcanized on.

The above-mentioned features of the invention can arbitrarily be combined with one another.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, and gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

### LISTING OF REFERENCE NUMERAL (PART OF THE SPECIFICATION)

100 Charge air hose-or-Engine coolant hose
102 Hose-shaped base member
104 Textile reinforcement
106 Outer layer
108 Abrasion resistant reinforcement patch
202 Underhood component

What is claimed is:

1. A charge air hose for motor vehicles, comprising:
a hose-shaped base member;
a textile reinforcement arranged to directly contact the surface of the base member;
an outer layer arranged outwardly the textile reinforcement, wherein the outer layer defines an outer surface of the charge air hose; and
an abrasion resistant reinforcement patch embedded in localized area of the outer surface of the charge air hose.

2. The charge air hose according to claim 1, wherein the hose-shaped base member is an unvulcanized, elastomer-containing hose.

3. The charge air hose according to claim 1, wherein the textile reinforcement comprises one or more of a woven fabric, a knitted fabric, knitted reinforcement or braided reinforcement.

4. The charge air hose according to claim 1, wherein yarns forming the textile reinforcement are provided with an impregnation.

5. The charge air hose according to claim 1, wherein the abrasion resistant reinforcement patch comprises a woven or knitted fabric, a fabric mesh or a braid.

6. The charge air hose according to claim 1, wherein yarns forming the abrasion resistant reinforcement patch are provided with an impregnation.

7. The charge air hose according to claim 1, wherein the abrasion resistant reinforcement patch comprises a coating.

8. The charge air hose according to claim 1, wherein the abrasion resistant reinforcement patch is in contact with another underhood component.

9. An engine coolant hose comprising:
a hose-shaped base member;
a textile reinforcement arranged to directly contact the surface of the base member;
an outer layer arranged outwardly the textile reinforcement, wherein the outer layer defines an outer surface of the engine coolant hose; and
an abrasion resistant reinforcement patch embedded in localized area of the outer surface of the engine coolant hose.

10. The engine coolant hose according to claim 9, wherein the hose-shaped base member is an unvulcanized, elastomer-containing hose.

11. The engine coolant hose according to claim 9, wherein the textile reinforcement comprises one or more of a woven fabric, knitted fabric, knitted reinforcement or braided reinforcement.

12. The engine coolant hose according to claim 9, wherein yarns forming the textile reinforcement are provided with an impregnation.

13. The engine coolant hose according to claim 9, wherein the abrasion resistant reinforcement patch comprises a woven fabric, a knitted fabric, a fabric mesh or a fabric braid.

14. The engine coolant air hose according to claim 9, wherein yarns forming the abrasion resistant reinforcement patch are provided with an impregnation.

15. The engine coolant hose according to claim 9, wherein the abrasion resistant reinforcement patch comprises a coating.

16. The engine coolant hose according to claim 9, wherein the abrasion resistant reinforcement patch is in contact with another underhood component.

17. A method of manufacturing a hose for motor vehicles, comprising the following steps:
providing an elastomer-containing hose as a hose-shaped base member;
applying a textile reinforcement directly onto the surface of the elastomer-containing hose;
applying an outer layer arranged outwardly from the textile reinforcement, wherein the outer layer defines an outer surface of the hose;
embedding an abrasion resistant reinforcement patch in localized area of the outer surface of the hose; and,
vulcanizing the hose.

18. The method according to claim 17, wherein the hose is an engine coolant hose.

19. The method according to claim 17, wherein the hose is a charge air hose.

20. The method according to claim 17, wherein the abrasion resistant reinforcement patch is in contact with another underhood component.
